(19) United States
(12) Patent Application Publication
(10) Pub. No.: US 2023/0397314 A1
(43) Pub. Date: Dec. 7, 2023

(54) LIGHTING CONTROL SYSTEM, METHOD AND DEVICE FOR DRIVING AT LEAST ONE LIGHT SOURCE

(71) Applicant: Orange, Issy-les-Moulineaux (FR)

(72) Inventors: Julien Cumin, CHATILLON CEDEX (FR); Kévin L'Hereec, CHATILLON CEDEX (FR)

(21) Appl. No.: 18/328,346

(22) Filed: Jun. 2, 2023

(30) Foreign Application Priority Data
Jun. 2, 2022 (FR) 2205336

(51) Int. Cl. H05B 47/105

(52) U.S. Cl. CPC H05B 47/105; G08B 21/182

(57) ABSTRACT

A method for driving at least one drivable light source is implemented by a driving device. The method includes receiving, from at least one brightness sensor, a message including items of information representative of a color of a light sensed by said at least one sensor, and checking whether or not a color of the light sensed by said at least one brightness sensor is within a preferred color range associated with said at least one sensor. Upon a determination that this is not the case, the method further includes sending (P70) to at least one drivable light source at least one driving command including color parameters to modify a color emitted by said light source according to said parameters such that the light detected by said at least one brightness sensor is within or approaches the preferred color range associated with this brightness sensor.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 2205336, filed Jun. 2, 2022, the disclosure of which is hereby incorporated by reference in its entirety.

### BACKGROUND

### Technical Field

Embodiments of the disclosed technology relate to the field of lighting control, in particular but without limitation in a domestic environment.

### Description of the Related Art

The use of remote-controlled bulbs has become widespread in the past few years and in particular allows:
the automatic turning on and off of a bulb according to the detection of a presence in a room;
the adjustment by the user of the light emitted by a bulb in a spectrum of colors, for example 16 million different colors.

Systems also allow the adjustment of a light emitted by a bulb or by a smartphone screen according to the time of day and/or of the geolocation.

But these solutions do not make it possible to control the light actually perceived by the user.

It has however been shown that this has a considerable impact on human physiology, particularly in the studies:
[1] A. J. Metz, S. D. Klein, F. Scholkmann, and al. Continuous coloured light altered human brain haemodynamics and oxygenation assessed by systemic physiology augmented functional near-infrared spectroscopy. In Nature Scientific Reports 7, 2017.
[2] G. Hoffmann, V. Gufler, A. Griesmacher, C. Bartenbach, M. Canazei, S. Staggl, W. Schobersberger. Effects of variable lighting intensities and colour temperatures on sulphatoxymelatonin and subjective mood in an experimental office workplace. In Applied Ergonomics, vol. 39 issue 6, 2008.

The disclosed technology has the aim of improving the existing solutions.

### SUMMARY

Thus, and according to a first aspect, embodiments of the disclosed technology relate to a method for driving at least one drivable light source implemented by a driving device, said method including steps of:
receiving, from at least one brightness sensor, a message including items of information representative of a color of a light picked up by said at least one sensor;
checking whether or not the color of the light sensed by said at least one brightness sensor is within a preferred color range associated with said at least one sensor; and when this is not the case:
sending to at least one drivable light source at least one driving command including color parameters to modify a color emitted by said at least one light source according to said parameters such that the light detected by said at least one brightness sensor is within or approaches the preferred color range associated with this brightness sensor.

Correspondingly, embodiments of the disclosed technology also relate to a driving device including:
a communicating module configured to receive, from at least one brightness sensor, a message including items of information representative of a color of a light picked up by said at least one sensor;
a controller configured to check whether or not the color of the light sensed by said at least one brightness sensor is within a preferred color range associated with said at least one sensor; and when this is not the case to control said communicating module so that it sends to at least one drivable light source at least one driving command including color parameters to modify a color emitted by said at least one light source according to said parameters such that the light detected by said at least one brightness sensor is within or approaches the preferred color range associated with this brightness sensor.

Embodiments of the disclosed technology also relate to a lighting control system including at least one driving device as stated above, at least one brightness sensor and at least one drivable light source.

In this document, the following terms will be used:
“drivable light source” refers to a light source configured to be able to receive a command and to emit a color defined by this command;
“driving device” refers to any device configured to be able to send a command to a drivable light source to modify the color emitted by this light source; and
“brightness sensor” refers to any brightness sensor configured to sense the colors of the light it receives:
“preferred color range associated with a sensor” refers to a range of colors within which one wishes the color of the light sensed by this sensor to be located.

The particular embodiments and advantages of the driving method set out hereinafter apply in the same way to the driving device and the lighting control system.

Thus, and in general, the disclosed technology can be implemented in a room to adjust the light emitted by one or more light sources so that the color of the light sensed by sensors installed in different places is in accordance with or tends toward a preferred color range associated with each of these sensors.

The disclosed technology allows a dynamic adjustment such as to counterbalance light variations which can occur in the environment of the lighting control system. For example, when the system is implemented in a room, the driving method can vary the color of the light emitted by one or more light sources when the light varies in the room (opening or closing a curtain or a blind, change in the weather, lighting given off by a television etc.)

Advantageously, the sensors can be placed in different places and associated with different preferred color ranges. For example in a room including a kitchen corner and a reading corner, a sensor installed in the kitchen corner can be associated with a relatively cool color range and a sensor installed in the reading corner can be associated with a relatively warm color range. Of course, sensors placed in different places can be associated with identical preferred color ranges.

In an embodiment, the parameters of the driving command are determined by a gradient descent.

This embodiment of the disclosed technology makes it possible to gradually vary the lighting of the drivable light sources toward their preferred color ranges.

For the implementation of the disclosed technology, the sensors can produce items of color information according to any format and the parameters of the colors sent to the light sources to drive them can be in any format. These formats can be identical or different.

In an embodiment of the disclosed technology, this format is identical and in accordance with the RGB format. Thus:
the messages received from the brightness sensors include the red, green and blue components of the colors sensed by these sensors; and
the driving commands sent to the light sources including the red, green and blue components of the colors to be emitted by these sources.

In an embodiment, the received items of information representative of the color sensed by said at least one brightness sensor are in a first format, and the driving method further includes a step of converting said items of information into a second color format, said gradient descent being implemented in a color space in accordance with this second color format.

For example, in an embodiment, said items of information representative of a color sensed by said at least one brightness sensor are in the RGB format and converted into the HSV format.

This is because it was advantageously determined by the inventors that the HSV format allowed for a spatial representation of the colors more suitable for the implementation of the gradient descent than the RGB format.

In an embodiment of the disclosed technology, a driving method includes, on receiving an activation signal coming from a so-called drivable light source, sending to this drivable light source a driving command so that the drivable light source emits a light with a default color, for example a white at 6000 K. This embodiment makes it possible to initialize the drivable light sources with a neutral light before this light is dynamically adjusted in accordance with the preferred color ranges.

In an embodiment, said checking step takes into account an average of the color of the light sensed by said at least one brightness sensor over a period of time, for example over one minute. This embodiment avoids having to adjust the light emitted by the drivable light sources too frequently, for example in reaction to a flash of light produced by a television screen.

In an embodiment, the driving method includes a step of issuing an alarm if a power of the light received by said at least one sensor is less than a threshold. This embodiment makes it possible to inform a user that a light sensor is obstructed by an obstacle for example.

In a particular embodiment, the different steps of the driving method are determined by computer program instructions or are implemented by a silicon chip comprising transistors suitable for constituting logic gates of a hard-wired non-programmable logic.

Consequently, the invention also relates to a computer program on an information medium, this program being able to be implemented in a controller computer, this program including instructions suitable for implementing the steps of a driving method as described above.

This program can use any programming language, and be in the form of source code, object code, or intermediate code between source code and object code, such as in a partially compiled form, or in any other desirable form.

The disclosed technology also relates to an information medium readable by a computer and including instructions for a computer program as mentioned above. The information medium can be any entity or device capable of storing the program. For example, the medium can include a storage means, such as a ROM, a non-volatile memory of flash type or else a magnetic recording means, for example a hard disk. Moreover, the information medium can be a transmissible medium such as an electrical or optical signal, which can be routed via an electrical or optical cable, by radio or by other means. The program according to the invention can in particular be downloaded over a network of Internet type. Alternatively, the information medium can be an integrated circuit into which the program is incorporated, the circuit being suitable for executing or being used in the execution of the method in question.

### BRIEF DESCRIPTION OF THE DRAWINGS

Other features and advantages of the disclosed technology will become apparent from the description given below, with reference to the appended drawings which illustrate exemplary embodiments thereof without any limitation. In the figures:

FIG. 1 shows a lighting control system in accordance with a particular embodiment of the disclosed technology.

FIG. 2 shows, in the form of a flow chart, steps of a lighting control method in accordance with an embodiment of the disclosed technology.

FIG. 3 shows a point in a color space corresponding to the HSV format.

FIG. 4 particularly illustrates a representative area of a preferred color range associated with a brightness sensor.

FIG. 5 illustrates a change in the color of the light detected by a brightness sensor.

FIG. 6 illustrates a gradient descent which can be implemented in a particular embodiment.

FIG. 7 shows a drivable light source.

FIG. 8 shows a brightness sensor.

FIG. 9 shows a driving device.

FIG. 10 shows a hardware architecture of a computer.

Appendix 1 details a method for converting a color in the RGB format into a color in the HSV format.

Appendix 2 details a method for converting a color in the HSV format into a color in the RGB format.

### DETAILED DESCRIPTION

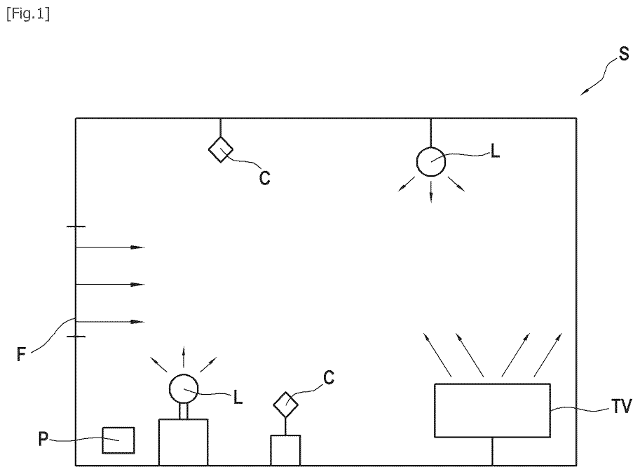

FIG. 1 shows a lighting control system S in accordance with a particular mode of implementation of the disclosed technology, this system S including N_{C} brightness sensors C (N_{C}≥1), N L drivable light sources L, (N_{L}≥1), and at least one driving device P. In this example, the system S is placed in a room which contains, in addition to the drivable light sources, a first light source consisting of a window F and a second light source consisting of a television TV.

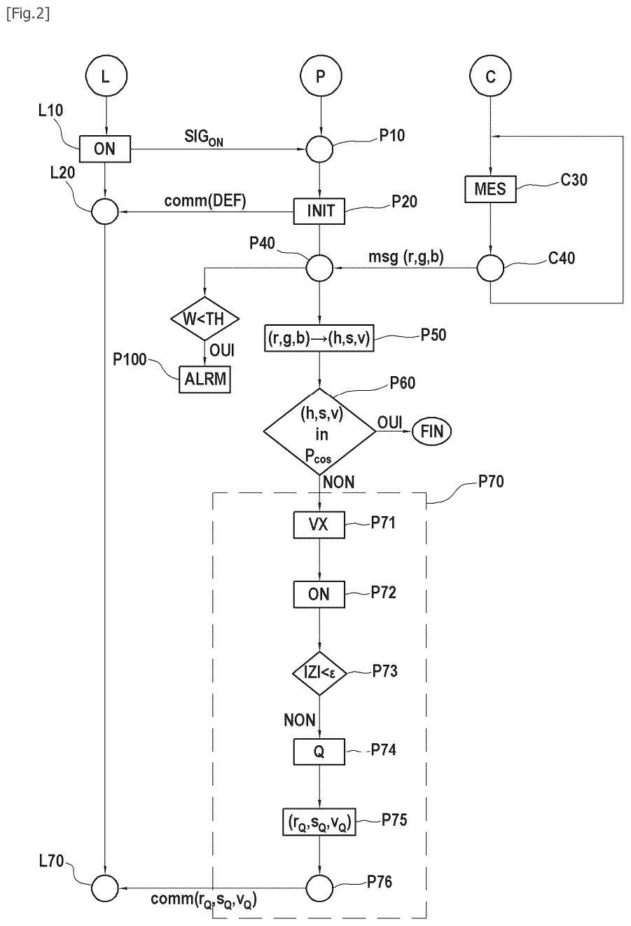

FIG. 2 shows the main steps implemented by the different elements L, C, P of the system S in a particular embodiment of the disclosed technology.

In the embodiment described here, when a drivable light source L is turned on, for example by means of a switch or a remote control, it sends, during a step L10, an activation signal SIG_{ON}. This activation signal SIG_{ON} is received by the driving device P during a step P10.

In the embodiment described here, when the driving device P receives an activation signal SIG_{ON} coming from a drivable light source L, it sends to this drivable light source L, during a step P20, a command comm(DEF) so that it emits a light with a default color, for example a white at 6000 K (Kelvins). This command is received by the drivable light source L during a step L20.

In the embodiment described here, during a step C30 implemented iteratively, for example every minute, at least one brightness sensor C senses a light and measures items of information representative of the color of this light.

In the embodiment described here, the brightness sensors C are RGB sensors configured to measure the red, green and blue components of the light they detect.

In the embodiment described here, a brightness sensor C sends, during a step C40, a message msg(r,g,b) including the red, green and blue components of the light detected by this sensor to the driving device P. This message msg(r,g,b) is received by the driving device P during a step P40.

In the embodiment described here, the message msg further includes a power W of the light received by the brightness sensor C and if this power is less than a threshold TH, the driving device P issues an alarm (step P100).

In the embodiment described here, when the driving device P receives a message including red, green and blue components of the color of the light (the first format within the meaning of the present specification), during a step P50 it converts these components into another color format (the second format within the meaning of the present specification).

This conversion is optional. It is particularly advantageous when the second color format allows a spatial representation of colors more suitable for the implementation of the gradient descent than the first color format.

Firstly, the HSV format makes it possible to separate the item of color information and the item of brightness information: unlike the RGB format, the HSV format makes it possible to independently handle the item of color information (Hue, Saturation) and the item of brightness information (Value).

Thus, making use of the HSV format to implement a gradient descent in a chromaticity plane (i.e. a hue-saturation plane) is particularly suitable for control of the color of a light source. Along the gradient descent in a chromaticity plane (hue-saturation), only the color emitted by the light source will be modified and the brightness remains unchanged.

Moreover, the HSV format is based on the perception of colors by the human eye: it is directly based on the perception of colors by the human eye, which is not the case of the RGB format.

Supposing there are two colors defined in the HSV format and represented by two points P1 and P2 in a chromaticity plane, the human eye will perceive in the same way:
the superposition of two light sources of respective colors P1 and P2, and
a single light source of a color corresponding to the average (i.e. the barycenter) of P1 and P2.

Contrariwise, this property is not observed for two colors defined in the RGB format. The use of the HSV format during a transition between two given colors is suitable for the perception of colors by the human eye: during such a transition, a user perceives fewer color variations if the HSV format is used rather than the RGB format.

In the embodiment described here, the red, green and blue components of the color of the light are converted into components (h, s, v) of the HSV (hue-saturation-value) format according to the method detailed hereinafter in Appendix 1.

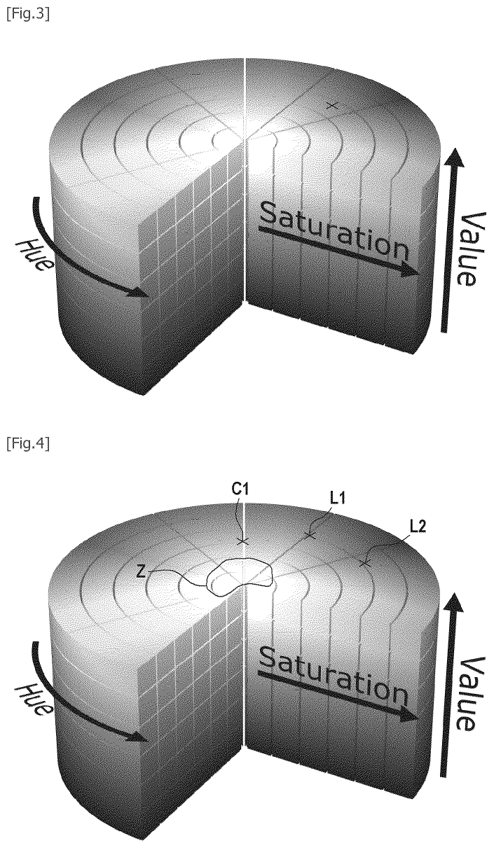

FIG. 3 shows, as a cross, a point in a color space corresponding to the HSV format.

In such a color space, in a known manner, pure hues are shown on the edge of the space. For a color hue, the saturation (representing the distance to white) is lower the closer one is to the outside of the space.

When the lighting control system S includes several brightness sensors L, the driving device P potentially receives from each of these sensors a message including the red, green and blue components of the color of the light sensed by this sensor. It obtains, by conversion, the components of each of these colors in the HSV format.

In the embodiment described here, during a step P60, the driving device P checks whether or not the color of the light sensed by a brightness sensor C is within a preferred color range P_{COL} associated with this sensor C.

For this purpose, in the embodiment described here, the driving device P includes a database BD_{P} wherein a preferred color range is associated with each brightness sensor C.

In an embodiment, the preferred color range associated with a sensor can be a function of variable parameters, for example the time, the time of year, a user detected in proximity to the sensor, an operating environment (domestic, workspace application etc.).

FIG. 4 illustrates, in a color space corresponding to the HSV format, for a system S including a brightness sensor C1 and two drivable light sources L1 and L2:
a point L1 representing the color of the light emitted by the drivable light source L1;
a point L2 representing the color of the light emitted by the drivable light source L2;
a point C1 representing the color of the light detected by the brightness sensor C1; and
an area Z representative of the preferred color range P_{COL} associated with the brightness sensor C1.

In the example of FIG. 4, the color of the light detected by the brightness sensor C1 is not within the preferred color range associated with the brightness sensor C1, so the result of the test of step P60 is negative.

In an embodiment of the disclosed technology, during the test P60, the driving device P does not consider the color of the light sensed instantaneously by a brightness sensor but considers an average of the color of the light sensed over a period of time.

In the embodiment described here, when the driving device P determines that the color of the light detected by at least one brightness sensor C is not within the preferred color range associated with this brightness sensor C (negative result of the test of step P60), during a step P70 detailed below, the driving device P sends at least one command comm(r_{Q}, g_{Q},b_{Q}) to at least one drivable light source L to modify the color emitted by this light source such that the light detected by this brightness sensor (C) is within or approaches the preferred color range associated with this brightness sensor (C).

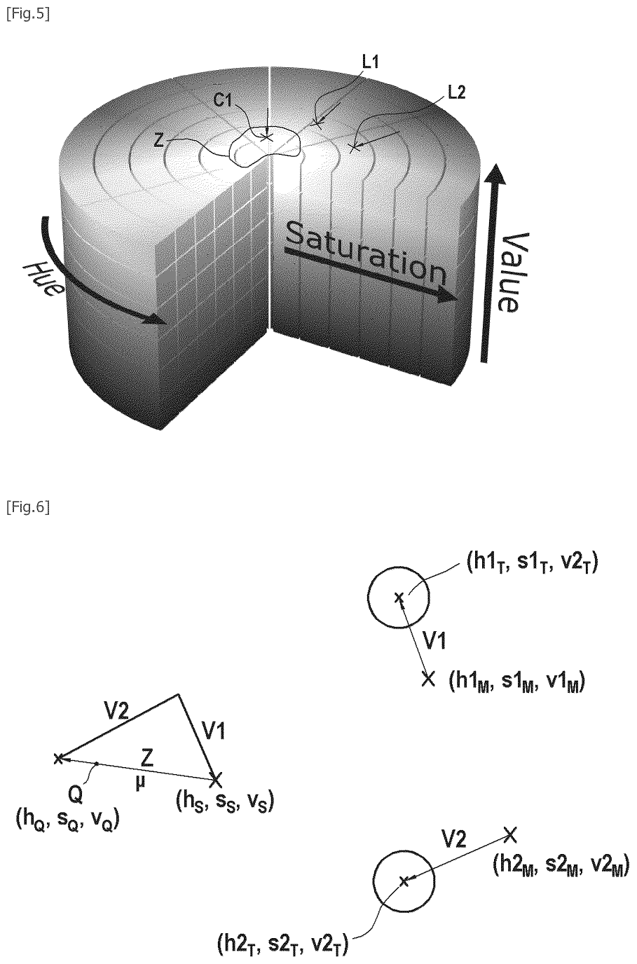

Based on the example of FIG. 4, FIG. 5 illustrates the modifications of the colors emitted by the drivable light sources L1 and L2, the impact on the color of the light detected by the brightness sensor C1, and the fact that this color is then within the preferred color range P_{COL} associated with the brightness sensor C1. Under these conditions, the result of the test of step P60 is positive.

A description, with reference to FIG. 6, will be given hereinafter of a gradient descent making it possible to implement the step P70 mentioned above, in an embodiment. This gradient descent makes it possible to gradually vary the lighting of a drivable light source so that brightness sensors (two in the example hereinafter) detect a light, the color of which corresponds to the preferred color ranges associated with this sensor.

Using the notation of Appendices 1 and 2, the following notation will be used:
r_{S}, g_{S}, b_{S} denote the red, green and blue components of the light emitted by the light source and h_{S},s_{S},v_{S} denote the HSV components of this light (obtained by the conversion in Appendix 1);
r1_{M}, g1_{M}, b1_{M} denote the red, green and blue components of the (measured) light sensed by the sensor C1 and h1_{M}, s1_{M}, v1_{M} denote the HSV components of this light (obtained by the conversion in Appendix 1);
h1_{T}, s1_{T}, v1_{T} denote the HSV components of a light of the preferred color range associated with the sensor C1 (for example the barycenter of this range) and r1_{T}, g1_{T}, b1_{T} denote the red, green and blue components of this light (obtained by conversion according to the method set out in Appendix 2);
r2_{M}, g2_{M}, b2_{M} denote the red, green and blue components of the (measured) light sensed by the sensor C2 and h2_{M}, s2_{M}, v2_{M} denote the HSV components of this light (obtained by the conversion in Appendix 1);
h2_{T}, s2_{T}, v2_{T} denote the HSV components of a light of the preferred color range associated with the sensor C2 (for example the barycenter of this range) and r2_{T}, g2_{T},b2_{T} denote the red, green and blue components of this light (obtained by conversion according to the method set out in Appendix 2).

During a sub-step P71, the driving device P computes for each sensor CX the vector VX=(hX_{T}−hX_{M},sX_{T}−sX_{M},vX_{T}−vX_{M}).

During a sub-step P72, the driving device P sums the vectors VX to obtain a single vector Z. In this example, with two sensors C1 and C2:

Z=V1+V2=(h1_{T}+h2_{T}−h1_{M}−h2_{M},s1_{T}+s2_{T}−s1_{M}−s2_{M},v1_{T}+v2_{T}−v1_{M}−v2_{T})

During a sub-step P73, the driving device P determines whether or not the norm of the vector Z is less than a threshold ε, below which it is considered that the algorithm has converged on a local minimum.

If the norm of the vector Z is greater than or equal to the threshold ε, during a sub-step P74, the driving device P computes a point Q=(h_{Q},s_{Q},v_{Q})=(μ·Z+(h_{S},s_{S},v_{S})) obtained by displacement in the sense and the direction of the vector Z from the point (h_{S},s_{S},v_{S}) corresponding to the emission of the light source where μ is a parameter of control of the variation speed between 0 and 1.

Those skilled in the art will understand that the convergence of the algorithm cannot be guaranteed given that the level of impact of the light emitted by a light source on the values sensed by the sensors is in theory not known, and that the environment other than the drivable light sources also has an effect (natural light, etc.). Moreover, when several sensors are used, it can be physically impossible to satisfy them all at the same time, even with several sources. On the other hand, for values of ii, it can be guaranteed that this algorithm does not diverge and that one will therefore remain “around” preferred color ranges, without necessarily being able to reach them to the nearest E.

In an embodiment of the disclosed technology, the drivable light sources (L) are configured to be driven by commands including color parameters in the RGB format and during a sub-step P75, the driving device P converts, according to the method set out in Appendix 2, the HSV coordinates of this point Q into red, green and blue coordinates (r_{Q}, g_{Q},b_{Q})

During a sub-step, P76, the driving device P sends a command comm(r_{Q}, g_{Q},b_{Q}) to the drivable light source so that it emits a light with these red, green and blue components.

In another embodiment of the disclosed technology, the drivable light sources (L) are configured to be driven by commands including color parameters in the HSV format. The converting step P75 is not executed and during step P70, the driving device sends to the drivable light source (L) a command comm(h_{Q},s_{Q},v_{Q}), the parameters of which are the components of the color corresponding to the point (Q) in the HSV format as determined in the step P74.

The command comm is received by the light source during a step L70 and the light source emits a color according to the parameters of this command. The lights then sensed by the brightness sensors are then within or approach the preferred color ranges associated with these sensors.

When the system includes several light sources SY (for example two sources S1, S2):

1/ In the sub-step P72, the driving device sums the vectors CX to obtain a single vector Z weighted by weights wY respectively associated with the sources SY, all initialized to 1.

In our example:

Z=(w1·(h1_{T}−h1_{M})+w2·(h2_{T}−h2_{M}),w1·(s1_{T}−s1_{M})+w2·(s2_{T}−s2_{M}),w1·(v1_{T}−v1_{M})+w2·(v2_{T}−v2_{M}))

2/ During the sub-step P74, for each source SY, the driving device P computes a point QY=(h_{QY},s_{QY},v_{QY})=(μ·Z+(h_{SY},s_{SY},v_{SY})) obtained by displacement in the sense and the direction of the vector Z from the point (h_{SY},s_{SY},v_{SY}) corresponding to the emission of the light source SY where μ is a parameter of control of the variation speed between 0 and 1.

3/ During the sub-step P75, the driving device P converts, for each source SY, the HSV coordinates of the point QY into red, green and blue coordinates (r_{QY},g_{QY},b_{QY})

4/ During the sub-step P76, the driving device P sends, to each source SY, a command comm(r_{QY},g_{QY},b_{QY}) so that it emits a light with these red, green and blue components.

5/ The driving device determines, for each sensor CX, the difference WX between the color measured by this sensor before and after driving of the sources LY. It adjusts the weight wY associated with each source SY based on these differences WX and on a predefined function f.

For example, the function f can be defined by: wY′=wY+tanh (WX), where wY′ represents the adjusted weight, and tanh the hyperbolic tangent function, or another similar sigmoid function making it possible to bound the weight variation factor (for example to +1/−1 max with tanh). The fact of bounding the weight variation factor in a precise interval makes it possible to avoid value divergences.

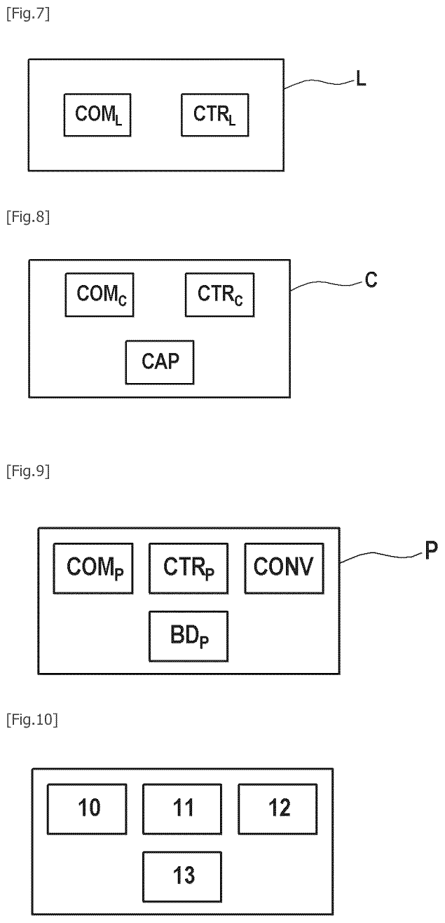

FIG. 7 shows a drivable light source L. It particularly includes a communication model COM_{L} and a controller CTR_{L}. This controller is configured to implement the steps L10 to L70 described with reference to FIG. 2. The source in particular receives commands from the drivable light source by its communicating means and the controller modifies the color of the light emitted by the source based on the parameters of this command.

FIG. 8 shows a brightness sensor C. It includes a communicating module COM_{C}, a controller CTR_{C} and a sensor CAP of the colors of the light in the strict sense. This controller is configured to implement steps C10 to C40 described with reference to FIG. 2. In particular, the sensor CAP is configured to deliver to the controller CRT_{P} the color of the light it receives at a given time, for example the red, green and blue components of the light. The controller CTR_{P} controls the communicating module COM_{P} so that it sends the color components to the driving device P.

FIG. 9 shows a driving device P. It includes:
a communicating module COM_{P},
a controller CTR_{P},
a conversion module CONV configured to convert RGB components into HSV components, and conversely,
and a database BD_{P} which associates a preferred color range with each brightness sensor C.

The controller CTR_{P} is configured to implement the steps P10 to P70 described with reference to FIG. 2. In particular, this controller determines, by a gradient descent, the commands to send to the light sources so that the colors of the lights detected by the sensors correspond to or are near the preferred ranges associated with these sensors.

The communicating modules COM_{C},COM_{L},COM_{P} are configured to allow the brightness sensors, the drivable light sources and the driving device to communicate with one another, for example according to the Bluetooth or Wifi protocol.

A drivable light source L, a brightness sensor C and a driving device P can have the hardware architecture of a computer shown in FIG. 10 and can in particular include a processor 10, a read-only memory 11, a random-access memory 12 and a rewritable non-volatile memory 13.

For a brightness sensor C, the read-only memory 11 can constitute a recording medium in accordance with an embodiment of the disclosed technology, readable by the processor 10, and on which is recorded a computer program PROG L configured to implement steps C10 to C40 described with reference to FIG. 2 when it is executed by the processor 10.

For the drivable light source L, the read-only memory 11 can constitute a recording medium in accordance with an embodiment of the disclosed technology, readable by the processor 10, and on which is recorded a computer program PROG L configured to implement steps L10 to L70 described with reference to FIG. 2 when it is executed by the processor 10.

For a driving device P, the read-only memory 11 can constitute a recording medium in accordance with an embodiment of the disclosed technology, readable by the processor 10, and on which is recorded a computer program PROG_{P} configured to implement the steps P10 to P70 described with reference to FIG. 2 when it is executed by the processor 10. The rewritable non-volatile memory 13 can include the database BD_{C}.

### APPENDIX 1

This appendix describes how to convert a point of color represented by its R (red), G (green) and B (blue) components into HSV (hue-saturation-value).

It is assumed here that each of the R, G, B components is an integer in {0, . . . , 255}; in the following formulae, RGB values between 0 and 1 are used (dividing each of the components by 255).

$$r , g , b , s , v ∈ [ 0 , 1 ] \\ h ∈ [ 0 , 360 [ \\ max = max ( r , g , b ) , min = min ( r , g , b ) \\ h = \{ \begin{matrix}0 if max = min \\ ( 60 ° \times \frac{g - b}{max - min} + 360 ° ) mod 360 ° if max = r \\ ( 60 ° \times \frac{b - r}{max - min} + 120 ° ) if max = g \\ ( 60 ° \times \frac{r - g}{max - min} + 240 ° ) if max = b\end{matrix} \\ s = \{ \begin{matrix}0 if max = 0 \\ 1 - \frac{min}{max} otherwise\end{matrix} \\ v = max$$

### APPENDIX 2

This appendix describes how to convert a point of color defined by its HSV (hue-saturation-value) components into R (red), G (green) and B (blue) components.

$$r , g , b , s , v ∈ [ 0 , 1 ] \\ h ∈ [ 0 , 360 [ \\ {h}_{i} = ⌊ \frac{h}{60} ⌋ mod 6 \\ f = \frac{h}{60} - {h}_{i} \\ l = v \times ( 1 - s ) \\ m = v \times ( 1 - f \times s ) \\ n = v \times ( 1 - ( 1 - f ) \times s ) \\ ( r , g , b ) = \{ \begin{matrix}( v , n , l ) if {h}_{i} = 0 \\ ( m , v , l ) if {h}_{i} = 1 \\ ( l , v , n ) if {h}_{i} = 2 \\ ( l , m , v ) if {h}_{i} = 3 \\ ( n , l , v ) if {h}_{i} = 4 \\ ( v , l , m ) if {h}_{i} = 5\end{matrix}$$

What is claimed is:

1. A method for driving at least one drivable light source implemented by a driving device, said method comprising:
receiving, from at least one brightness sensor, a message including items of information representative of a color of a light sensed by said at least one brightness sensor;
determining whether or not the color of the light sensed by said at least one brightness sensor is within a preferred color range associated with said at least one sensor; and, in response to a determination that this is not the case:
sending to at least one drivable light source at least one driving command including color parameters to modify a color emitted by said at least one light source according to said parameters such that the color of the light sensed by said at least one brightness sensor is within or approaches the preferred color range associated with this brightness sensor.

2. The method of claim 1, wherein said determining takes into account an average of the color of the light sensed by said at least one brightness sensor over a period of time.

3. The method of claim 1, wherein said parameters of said driving command are determined by a gradient descent.

4. The method of claim 1, wherein said received items of information representative of the color of the light sensed by said at least one brightness sensor are in a first format, said method further comprising converting said items of information into a second color format, said gradient descent being implemented in a color space in accordance with this second color format.

5. The method of claim 4, wherein said items of information representative of the color of the light sensed by said at least one brightness sensor are in the RGB format and converted into the HSV format.

6. The method of claim 1, including; on receiving an activation signal coming from a drivable light source, sending to this drivable light source a driving command so that it emits a light with a default color.

7. The method of claim 1, further comprising issuing an alarm upon a determination that a power of the light sensed by said at least one brightness sensor is less than a threshold.

8. A driving device, comprising:
a communicating module configured to receive, from at least one brightness sensor, a message including items of information representative of a color of a light sensed by said at least one sensor;
a controller configured to determine whether or not the color of the light sensed by said at least one brightness sensor is within a preferred color range associated with said at least one sensor; and in response to a determination that this is not the case, control said communicating module so that it sends to at least one drivable light source at least one driving command including color parameters to modify a color emitted by said at least one light source according to said parameters such that the light sensed by said at least one brightness sensor is within or approaches the preferred color range associated with this brightness sensor.

9. A lighting control system, comprising:
at least one driving device of claim 8,
at least one brightness sensor, and
at least one drivable light source.

10. A non-transitory computer readable medium having stored thereon instructions which, when executed by a processor, cause the processor to implement the method of claim 1.
